(19) United States
(12) Patent Application Publication
(10) Pub. No.: US 2026/0027850 A1
(43) Pub. Date: Jan. 29, 2026

(54) CLIP AND BOTTLE OPENER

(71) Applicant: B/E Aerospace, Inc., Winston Salem, NC (US)

(72) Inventors: John Erick Dimatatac Malabanan, San Pascual (PH); Danica Paula Sergote Laurio, Marikina (PH); Henna Grace Torres Corpuz, Padre Garcia (PH); Alvin Jay Pua Ymson, Calamba (PH); Ralph Aaron Flores Velasquez, San Pascual (PH)

(73) Assignee: B/E Aerospace, Inc., Winston Salem, NC (US)

(21) Appl. No.: 19/265,963

(22) Filed: Jul. 10, 2025

(30) Foreign Application Priority Data
Jul. 25, 2024 (EP) 24191014

(51) Int. Cl. B42F 1/00; B67B 7/16

(52) U.S. Cl. CPC B42F 1/006; B67B 7/16

(57) ABSTRACT

A clip including: a first arm including a mounting point at which the clip is mountable; a biasing means configured to bias the first arm into a holding position; and wherein the first arm comprises a bottle opener.

### CROSS-REFERENCE TO RELATED APPLICATIONS

This application claims priority to EP patent application Ser. No. 24/191,014.0, filed Jul. 25, 2024 and titled “CLIP AND BOTTLE OPENER,” which is incorporated by reference herein in its entirety for all purposes

### FIELD

This disclosure relates to a clip and bottle opener. In particular, the disclosure may be applicable to a clip and bottle opener for mounting to a galley component of an aircraft

### BACKGROUND

Tools such as clips and bottle openers are often used on board aircraft. Typically, each tool is specially adapted to perform one task, meaning that a different tool is needed for each task. This may be undesirable on board aircraft, where space is limited and it is better to minimize the weight being carried on board.

Furthermore, each tool may be located on a different part of the cabin or attached to a different point in the galley. A person using these tools might need to move between locations on board the aircraft to perform different tasks. This can be inconvenient on board a busy flight. Furthermore, having a large number of tools visible inside the cabin of the aircraft could negatively affect the appearance of the cabin.

The present disclosure aims to address some of these problems by providing a clip including a bottle opener.

### SUMMARY

According to a first aspect of the present disclosure, there is provided a clip comprising:
a first arm comprising a mounting point at which the clip is mountable;
a biasing means configured to bias the first arm into a holding position; and
wherein the first arm comprises a bottle opener.

In some examples, the clip is configured to hold an object, such as one or more pieces of paper, when the first arm is in the holding position. In the holding position, the first arm may be configured to exert a force on the object to hold the object in place. The force exerted on the object may be applied at least in part by the biasing means acting upon the first arm. A counterforce may be applied to the clip against the force of the biasing means to move the first arm to a non-holding position so as to release any held objects.

Any portion of the first arm may be used to hold an object. In some examples, the portion of the first arm extends from an end of the first arm. In some examples, the portion extends along approximately 25% of the length of the arm, optionally approximately 50% of the length of the arm, optionally substantially the whole length of the arm.

In some examples, a force exerted on the first arm to remove the bottle cap from a bottle acts to bias the first arm into the holding position. Therefore, using the bottle opener on the first arm does not prevent the clip from being used to hold an object. Using the bottle opener on the first arm helps to apply a greater force to hold an object in the clip.

In some examples, the bottle opener is shaped to receive at least part of a bottle cap. For example, the bottle opener may comprise a hole configured to receive at least part of a bottle cap (e.g. owing to its shape and size). At least part of a bottle cap may be placed inside the hole and an edge of the hole used to exert a force on the bottle cap to remove the bottle cap from a bottle. In some examples, the bottle opener comprises a hook on the first arm or extending from the first arm, wherein the hook is configured to receive at least part of a bottle cap (e.g. owing to its shape and size). The hook may be placed over at least part of a bottle cap and used to exert a force on the bottle cap to remove the bottle cap from a bottle.

In some examples, the bottle may be moved (e.g. rotated) to remove the bottle cap from the bottle while the clip remains substantially stationary.

In some examples, the clip is configured to remove a crown cork bottle cap from a bottle. A crown cork bottle cap comprises a flat, round top and a crimped edge extending substantially perpendicularly downwards. The crimped edge comprises a plurality of teeth formed in the crimps. Crown cork bottle caps are typically formed from metal and/or plastic.

In some examples, the clip comprises a first surface configured to engage with a first side of the bottle cap; and
wherein a force exerted on the first surface of the first arm to remove the bottle cap from a bottle acts to bias the first arm into the holding position.

In some examples, the first arm comprises a hole shaped to receive at least part of a bottle cap; and
wherein the first surface is an edge of the hole.

In some examples, the first side of the bottle cap is the underside of one or more teeth of the bottle cap.

Hence, the edge of the hole is configured to hook over the teeth of the bottle cap and engage with the underside of the teeth. A force can be exerted from the edge of the hole to the underside of the teeth of the bottle cap to remove the bottle cap from a bottle.

In some examples, the clip comprises a second surface configured to engage with a second side of the bottle cap; and wherein the second surface is a bracing surface configured to stabilize the bottle cap. The bracing surface may be configured to stabilize the bottle cap as it is removed from the bottle. This can help to ensure that the bottle cap is correctly oriented such that the force to remove the bottle cap is applied in a suitable direction to remove the bottle cap from the bottle. The provision of the second surface may also help a user to place the bottle cap into the bottle opener correctly.

In some examples, the first arm comprises a protrusion; wherein the second surface is a side of the protrusion. The protrusion may have any shape and size. In some examples, the protrusion is an elongate strip extending across at least part of a width of the clip. In some examples, the protrusion is wedge shaped, such that the second surface has a greater surface area than an opposing surface of the protrusion. In some examples, the protrusion is angled such that it is configured to lie flat against the second side of the bottle cap when acting as a bracing surface.

In some examples, the second side of the bottle cap is a top surface of the bottle cap. In a crown cork bottle cap, the top surface of the bottle is a flat, round surface.

In some examples, the first surface is located above the second surface when the bottle opener is in use. In some embodiments, this may ensure that the bottle opener can be used without tilting the bottle to an extent that liquid pours out of the bottle during cap removal (e.g. the bottle remains substantially angled towards an upright position while the bottle cap is being removed or at least ends up in such a position so that minimal liquid escapes during the removal process).

In some examples, the first surface and the second surface are located on opposite sides of the mounting point. In some examples, the forces exerted on the first surface and the second surface to remove the bottle cap from a bottle act to produce a torque around the mounting point to bias the first arm into the holding position. Therefore, the first surface and the second surface are arranged such that using the bottle opener does not move the clip away from the holding position. Using the bottle opener on the first arm helps to apply a greater force to hold an object in the clip.

In some examples, the first arm comprises a first layer and a second layer, wherein:
the first layer and the second layer are separated by a cavity;
the first layer comprises the first surface; and
the second layer comprises the second surface and the mounting point.

The first arm may be configured such that the bottle cap extends at least partly into the cavity and rests between the first surface and the second surface. Therefore, the first surface and the second surface may be spaced apart by a distance less than or equal to the diameter of a bottle cap. The depth of the cavity (i.e. the separation of the first layer and the second layer) may be greater than a height of the bottle cap so that the bottle cap can be placed into the cavity for removal.

In some examples, the relative positions of the first surface and the second surface may be selected to ensure that, when the bottle opener is in use, the bottle does not tilt to an extent that liquid pours out of the bottle (e.g. the bottle remains substantially upright while the bottle cap is being removed or at least ends up in such a position at the end of the removal process). Hence, the distance by which the first layer and the second layer are separated (and hence the volume of the cavity) may be selected to ensure that the liquid remains in the bottle.

In some examples, the clip comprises a second arm;
wherein the first arm is mounted to the second arm at the mounting point; and
wherein the clip is configured to hold an object, such as one or more pieces of paper, between a portion of the first arm and a portion of the second arm when the first arm is in the holding position.

The first arm and/or the second arm may have any suitable and desired shape and size. In some examples, the first arm and the second arm have substantially the same footprint (e.g. substantially the same width and height).

The mounting point may be any type. In some examples, the mounting point comprises one or more apertures in the first arm and one or more corresponding protrusions in the second arm. The protrusion(s) extend into the aperture(s) to secure the first arm to the second arm. The mounting of the protrusion(s) in the aperture(s) may provide a pivot axis around which the first arm can pivot in use between the holding position and a non-holding position.

In the holding position, the first arm and the second arm may be brought into contact with an object, thereby exerting a force on the object to hold it in place between a portion of the first arm and a portion of the second arm.

Any portion of the first arm and the second arm may be used to hold an object. In some examples, the portions of the first arm and the second arm are portions extending from an end of each arm respectively. In some examples, the portions of the first arm and/or the second arm extend along approximately 25% of the length of the arm, optionally approximately 50% of the length of the arm, optionally substantially the whole length of the arm.

In some examples, the first arm is configured to pivot about the mounting point relative to the second arm, such that a portion of the first arm is brought into contact with a portion of the second arm in the holding position in the absence of an object being held in the clip. This may help to ensure that the clip is configured to hold objects having a small size (e.g. thin objects), such as one or more sheets of paper.

The first arm being configured to pivot about the second arm may also allow a portion of the first arm to be brought further away from a portion of the second arm when the first arm is not in the holding position. This may create more space inside the clip to allow an object to be inserted into the clip more easily.

In some examples, the first arm has an inner surface facing the second arm and an opposing outer surface;
wherein the second arm has an inner surface facing the first arm and an opposing outer surface; and
wherein the distance between the outer surface of the first arm and the outer surface of the second arm is less than 20 mm.

In some examples, the distance between the outer surface of the first arm and the outer surface of the second arm is no more than 16 mm. It may be desirable to minimize the distance between the outer surface of the first arm and the outer surface of the second arm. This may be particularly useful when the clip is mounted to another object (e.g. to the wall of a galley unit or to an intermediate mounting block), because it minimizes the distance by which the clip extends outwards from the object. In particular, this may be desirable when the clip is used on an aircraft where space is limited.

In some examples, the second arm is mountable to a block for attachment to a galley component of an aircraft. The galley component of the aircraft may be any type. For example, the galley component may be (part of) a storage unit of an aircraft.

The second arm may be mounted to the block in any way. For example, the second arm may comprise apertures configured to receive a fixing member such as a screw. In some examples, the second arm is substantially planar and the clip is configured to be mounted to the galley component such that the second arm is substantially vertical.

The block may be any type. In some examples, the block includes a first part and a second part. When the block is mounted to a surface, the first part of the block may rest on the exterior of the surface and the second part of the block may be recessed into the surface (e.g. embedded into the surface or resting on an opposing face of the surface). This may help to ensure that the clip can be securely mounted to the surface, such that a force can be applied to the clip to remove a bottle cap from a bottle.

In some examples, the biasing means is a spring. In some examples, the spring is connected between the first arm and the second arm of the clip.

In some examples, the clip is formed from a metal such as (stainless) steel or aluminium. The metal may be rigid, lightweight and/or resistant to water damage.

In some examples, the first arm comprises teeth for holding an object, such as one or more pieces of paper, when the first arm is in the holding position. The teeth may be located on the portion of the first arm that is brought into contact with a portion of the second arm in the holding position in the absence of an object being held in the clip. In some examples, the teeth extend over substantially the entire width of (the first arm of) the clip. The teeth may be configured to grip the object(s) being held in the clip.

In some examples, the clip comprises a recess or a trough configured to catch liquid that escapes from the bottle. Liquid may be collected in the recess or trough if spray is released from the bottle as it is opened and/or if condensation drips down the side of the bottle. The recess or trough thus prevents such liquid from falling to the floor or from dripping/spraying onto any papers held in the clip and instead the liquid is retained within the clip.

In some examples, the recess or trough is formed in the first arm of the clip. The recess or trough may be any suitable size and shape. The clip may have a volume suitable for holding approximately 1 ml of liquid. In some examples, the recess or trough extends over substantially the entire width of (the first arm of) the clip.

In some examples, the recess or trough is located underneath the bottle opener. This may help to ensure that the recess or trough is able to catch liquid from the bottle as it drips or falls downwards. In some examples, the recess or trough is located above the object(s) held in the clip (when present). This may help to reduce the amount of liquid that drips onto the object(s) being help in the clip.

In some examples, the edges of the clip are filleted. In some examples, the edges of the hole are filleted. That is, the edges of the clip and/or the hole are sloped or rounded with respect to the surfaces that they join. This may help to reduce the sharpness of the corners, thereby making the clip safer to use. The fillets may also help to reduce the profile of the clip. This may be particularly useful when the clip is mounted to another object, because it minimizes the distance by which the clip extends outwards from the object. In some examples, the fillets have a width of approximately 1 mm.

### BRIEF DESCRIPTION OF THE DRAWINGS

Certain examples of the present disclosure will now be described with reference to the accompanying drawings in which:

FIG. 1 is a perspective view of a clip in accordance with the present disclosure;

FIG. 2 is a side view of a clip in accordance with the present disclosure;

FIG. 3 is a plan view of a clip in accordance with the present disclosure;

FIGS. 4 and 5 are perspective views of a clip in accordance with the present disclosure being used as a bottle opener; and

FIG. 6 is a perspective view of a clip in accordance with the present disclosure mounted to a galley component of an aircraft and being used as a bottle opener.

### DETAILED DESCRIPTION

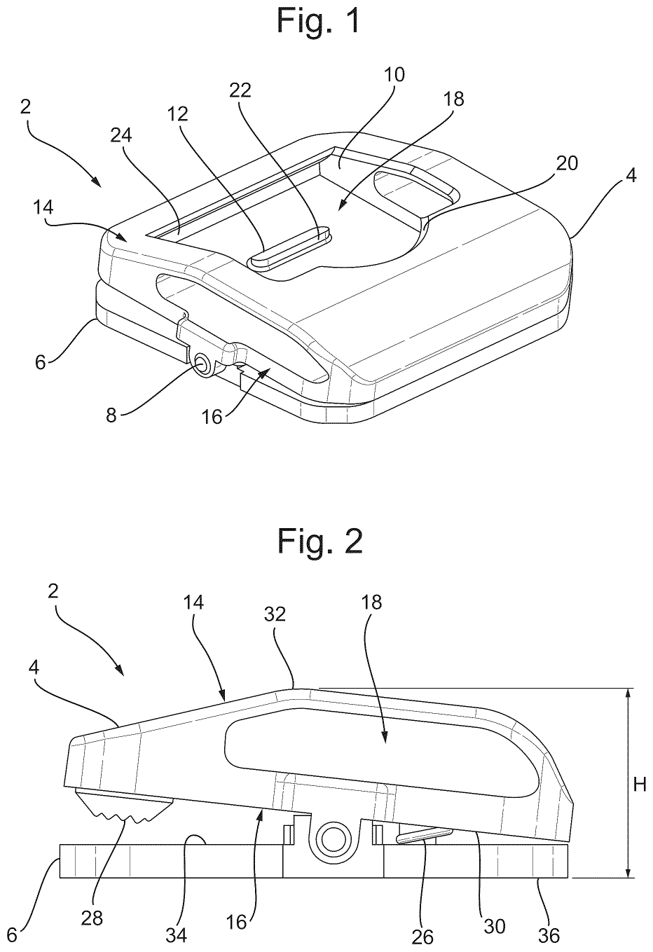

FIG. 1 is a perspective view of a clip 2 according to the present disclosure. In this example, the clip 2 includes a first arm 4 and a second arm 6.

The first arm 4 includes a mounting point 8. The first arm 4 is mounted to the second arm 6 at the mounting point 8. The first arm 4 is configured to pivot about the mounting point 8 relative to the second arm 6.

The first arm 4 includes a bottle opener. In this example, the first arm 4 includes a first layer 14 and a second layer 16 separated by a cavity 18. The bottle opener includes a hole 10 and a protrusion 12. The hole 10 is formed in a first layer 14 of the first arm 4. The protrusion 12 extends from a second layer 16 of the first arm 4 into the cavity 18.

The hole 10 is shaped to receive at least part of a bottle cap. That is, the size of the hole 10 is such that at least part of a bottle cap can be inserted into the hole 10. In particular, the hole 10 is shaped to receive at least part of a crown cork bottle cap.

The hole 10 includes a first surface 20 at its edge which is configured to engage with the underside of one or more teeth of the bottle cap. A force can be applied to the underside of the teeth of the bottle cap at the first surface 20 to remove the bottle cap from a bottle.

The protrusion 12 includes a second surface 22 on one side. The second surface 22 on the protrusion 12 is configured to engage with the top surface of the bottle cap. The bottle cap at least partly extends into the cavity 18 and rests between the first surface 20 and the second surface 22. Therefore, the first surface 20 and the second surface 22 are spaced apart by a distance less than or equal to the diameter of a bottle cap.

The second surface 22 of the protrusion 12 acts as a bracing surface that stabilizes the bottle cap as it is removed from the bottle. This can help to ensure that the bottle cap is correctly oriented such that the force to remove the bottle cap is applied in a suitable direction to remove the bottle cap from the bottle.

When the bottle opener is used, the force exerted on the first surface 20 to remove the bottle cap from a bottle acts to bias the first arm 4 into the holding position. A force is also exerted on the second surface 22 as the bottle cap is rested against it. As the first surface 20 and the second surface 22 are located on opposite sides of the mounting point, the forces exerted on the first surface 20 and the second surface 22 act to produce a torque around the mounting point 8. The torque biases the first arm 4 into the holding position.

Therefore, using the bottle opener on the first arm 4 does not prevent the clip 2 from being used to hold an object. In fact, using the bottle opener on the first arm 4 helps to apply a greater force to hold an object in the clip 2.

The clip 2 of FIG. 1 also includes a recess 24 configured to catch liquid from the bottle. For example, if some spray is released from the bottle as it is opened or condensation drips down the side of the bottle, it may be collected in the recess 24. This helps to reduce the amount of liquid that drips onto an object being help in the clip 2, if present. This also helps to facilitate cleaning of the clip 2.

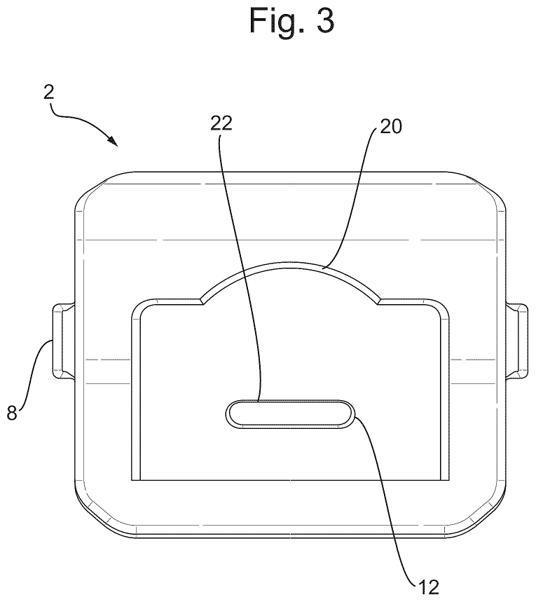

FIG. 2 is a side view of a clip 2 according to the present disclosure.

It can be seen that the clip 2 includes a spring 26 connected between the first arm 4 and the second arm 6. The spring 26 acts to bias the first arm 4 into the holding position (although in FIG. 2 the clip 2 is not shown in the non-holding position, i.e. with a force acting against the spring 26). To move into the holding position, the first arm 4 pivots about the mounting point 8 relative to the second arm 6, such that a portion of the first arm 4 is brought into contact with a portion of the second arm 6 when no object is being held.

It can also be seen that the first arm 4 includes teeth 28. The teeth 28 are located in the portion of the first arm 4 that is brought in contact with the second arm 6 when the clip 2 is in the holding position. Therefore, the teeth 28 help to hold an object in the clip 2 when the clip 2 is in the holding position.

In this embodiment, the first arm 4 has an inner surface 30 facing the second arm 6 and an opposing outer surface 32. The second arm 6 has an inner surface 34 facing the first arm 4 and an opposing outer surface 36. The distance between the outer surface 32 of the first arm 4 and the outer surface 36 of the second arm 6 is indicated by the distance H. In this example, the distance H is less than 20 mm. For example, the distance H may be approximately 16 mm.

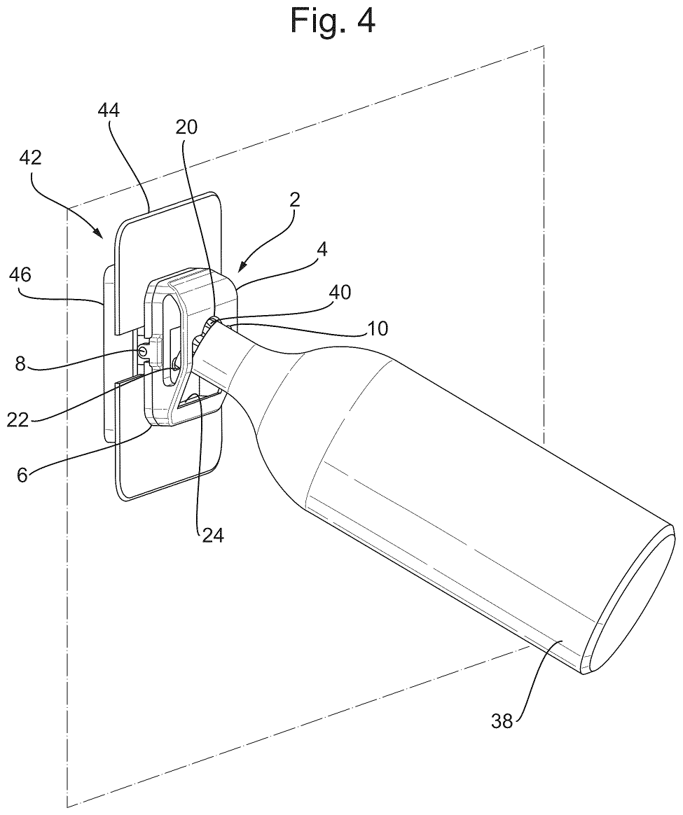

FIG. 3 is a plan view of a clip 2 according to the present disclosure.

In FIG. 3, it can be seen that the first surface 20 and the second surface 22 are located on opposite sides of the mounting point. When the bottle opener is used, the forces exerted on the first surface 20 and the second surface 22 act to produce a torque around the mounting point 8, which biases the first arm 4 into the holding position.

It can also be seen in FIGS. 1, 2 and 3 that the edges of the clip 2 and the edges of the hole 10 are filleted. That is, the edges are sloped with respect to the surfaces that they join. This helps to reduce the sharpness of the corners, thereby making the clip 2 safer to use. The fillets also help to reduce the profile of the clip 2. This is particularly useful when the clip 2 is mounted to another object, because it minimizes the distance by which the clip 2 extends outwards from the object.

Furthermore, the hole 10 is formed in the first arm 4 such that the portion of the first arm 4 that remains forms a closed surface around the perimeter of the hole 10. In this example, this helps to ensure that there are no protruding parts in the clip 2. This may help to reduce the chances of an object becoming unintentionally caught on the clip 2, thereby making the clip 2 safer and easier to use.

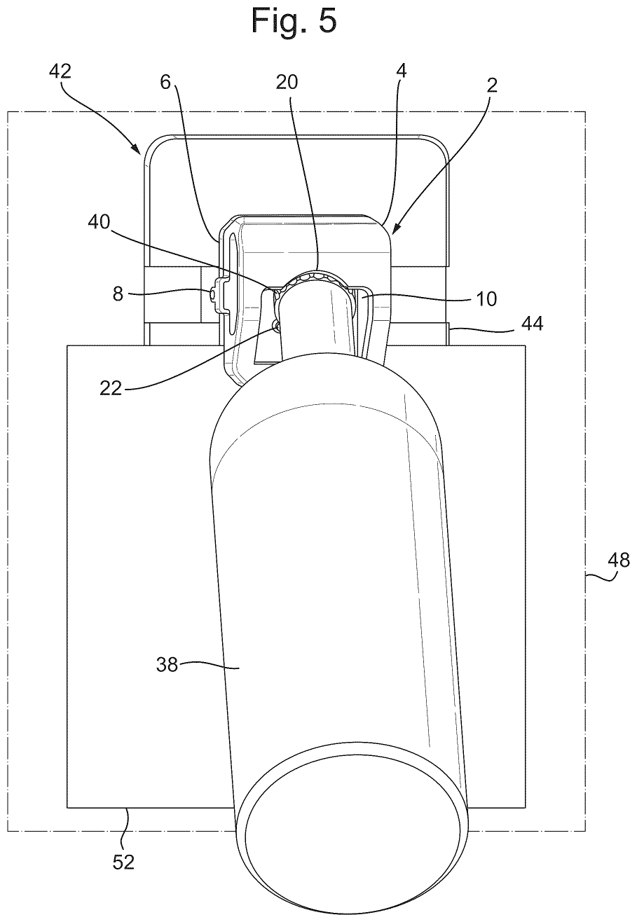

FIGS. 4 and 5 are perspective views of a clip 2 according to the present disclosure being used as a bottle opener.

The bottle 38 is sealed with a bottle cap 40, which in this example is a crown cork bottle cap. In order to insert the bottle cap into the bottle opener, the bottle 38 is held with the bottle cap at the top and at an angle with respect to the vertical direction.

The bottle cap 40 is inserted into the hole 10 such that the first surface 20 at the edge of the hole 10 engages with the underside of one or more teeth of the bottle cap 40. A force can be applied to the underside of the teeth of the bottle cap at the first surface 20 to remove the bottle cap from a bottle. The force may be applied by rotating the bottle 38 downwards towards the surface on which the clip 2 is mounted, while keeping the bottle cap 40 substantially stationary.

The bottle cap 40 also engages with the second surface 22, which acts as a bracing surface that stabilizes the bottle cap 40 as it is removed from the bottle 38. This can help to ensure that the bottle cap 40 is correctly oriented such that the force to remove the bottle cap 40 is applied in a suitable direction to remove the bottle cap 40 from the bottle 38.

It can be seen that the first surface 20 hooks over the edge of the bottle cap 40 while the top side of the bottle cap 40 is resting on the second surface 22. The provision of the second surface 22 can also help a user to place the bottle cap 40 into the bottle opener correctly.

In this example, the clip 2 is mounted such that the (planar) second arm 6 is substantially vertical and the mounting point 8 about which the first arm 4 pivots relative to the second arm 6 is substantially horizontal. In this orientation, the recess or trough 24 is located underneath the bottle opener. This helps to ensure that the recess or trough 24 is able to catch liquid from the bottle as it drips or falls downwards.

Furthermore, the portion of the first arm 4 and the second arm 6 in which an object 52 is held is located at the bottom of the clip, underneath the bottle opener and the recess or trough 24. This helps to ensure that the bottle opener can be accessed when an object 52 is being held in the clip 2. In FIG. 5, the clip 2 is shown holding an object 52.

In this example, the second arm 6 of the clip 2 is mounted to a block 42 for attachment to a galley component of an aircraft. In this example, the block 42 includes a first part 44 and a second part 46. It can be seen in FIG. 5 that, when the block 44 is mounted to a surface 48, the first part 44 of the block 42 rests on the exterior of the surface 48 and the second part 46 of the block 42 is recessed into the surface 48. For example, the second part 46 of the block 42 may be embedded into the surface 48 or resting on an opposing face of the surface 48. This may help to ensure that the clip 2 is securely mounted to the surface 48, such that a force can be applied to the clip 2 to remove a bottle cap 40 from a bottle 38 without removing the clip 2 from the surface 48.

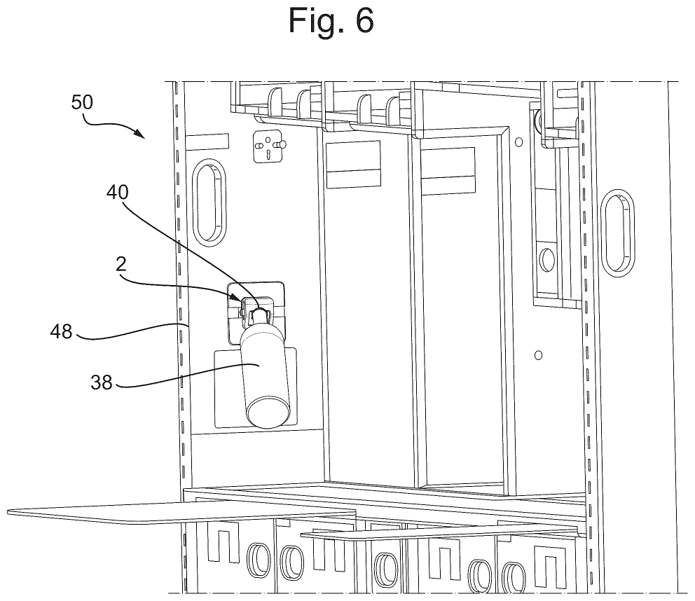

This may be particularly advantageous when the block 42 is being used to attach the clip 2 to a galley component of an aircraft (shown in FIG. 6). The surfaces of many galley components are formed from a material having a honeycomb structure, which may not be particularly strong if an object is attached directly to the structure (e.g. using fixing members such as screws). Therefore, using a block 42 such as the one shown in FIGS. 5 and 6 may help to ensure that a force can be applied to the clip 2 to remove a bottle cap 40 from a bottle 38 without removing the clip 2 from the galley component.

FIG. 6 is a perspective view of a clip 2 according to the present disclosure mounted to a galley component 50 of an aircraft being used as a bottle opener.

It can be seen that the clip 2 is mounted in a position where there is open space adjacent to the clip 2, in a direction extending outwards from the surface 48. This helps to ensure that the bottle 38 can be inserted into the bottle opener and rotated downwards to remove the bottle cap 40 from the bottle 38.

In some examples, the galley component 50 may be used for storing bottles. By mounting the clip 2 to the galley component 50, the bottle opener may be used without the user walking to another location on the aircraft after taking a bottle from the galley storage. This may help to decrease the time and effort required to serve drinks on board the aircraft.

In some examples, the clip 2 may be used to hold one or more pieces of paper. This may be particularly advantageous when the clip 2 is used to hold information relating to the drinks (e.g. a drinks menu or a list of drinks orders). Information relating to the drinks may be read without the user walking to another location on the aircraft after taking a bottle from the galley storage. This may help to decrease the time and effort required to serve drinks on board the aircraft.

Furthermore, the clip 2 may be mounted at or above waist height so that the objects being held can be seen easily and/or the bottle opener can be used while the user is in a standing position. This may be particularly advantageous when the clip 2 is used to hold information relating to the drinks (e.g. a drinks menu or a list of drinks orders).

In this example, the clip 2 is mounted on an interior surface of the galley component 50. This may help to ensure that the clip 2 does not protrude outwards of the galley component 50, thereby reducing the risk that objects are caught on the clip 2, for example.

1. A clip comprising:
a first arm comprising a mounting point at which the clip is mountable;
a biasing means configured to bias the first arm into a holding position; and
wherein the first arm comprises a bottle opener.

2. The clip as claimed in claim 1, wherein the clip is configured to hold an object, such as one or more pieces of paper, when the first arm is in the holding position.

3. The clip as claimed in claim 1, wherein a force exerted on the first arm to remove the bottle cap from a bottle acts to bias the first arm into the holding position.

4. The clip as claimed in claim 1, wherein the bottle opener is shaped to receive at least part of a bottle cap.

5. The clip as claimed in claim 1, wherein the bottle opener comprises a first surface configured to engage with a first side of the bottle cap; and
wherein a force exerted on the first surface of the bottle opener to remove the bottle cap from a bottle acts to bias the first arm into the holding position.

6. The clip as claimed in claim 5, wherein the bottle opener comprises a hole shaped to receive at least part of a bottle cap; and
wherein the first surface is an edge of the hole.

7. The clip as claimed in claim 5, wherein the first side of the bottle cap is the underside of one or more teeth of the bottle cap.

8. The clip as claimed in claim 5, wherein the bottle opener comprises a second surface configured to engage with a second side of the bottle cap; and
wherein the second surface is a bracing surface configured to stabilize the bottle cap.

9. The clip as claimed in claim 8, wherein the bottle opener comprises a protrusion;
wherein the second surface is a side of the protrusion.

10. The clip as claimed in claim 8, wherein the second side of the bottle cap is a top surface of the bottle cap.

11. The clip as claimed in claim 8, wherein the first surface and the second surface are located on opposite sides of the mounting point.

12. The clip as claimed in any of claim 8, wherein the first arm comprises a first layer and a second layer, wherein:
the first layer and the second layer are separated by a cavity;
the first layer comprises the first surface; and
the second layer comprises the second surface and the mounting point.

13. The clip as claimed in claim 1, wherein the clip comprises a second arm;
wherein the first arm is mounted to the second arm at the mounting point; and
wherein the clip is configured to hold an object, such as one or more pieces of paper, between a portion of the first arm and a portion of the second arm when the first arm is in the holding position.

14. The clip as claimed in claim 13, wherein the second arm is mountable to a block for attachment to a galley component of an aircraft.

15. The clip as claimed in claim 1, wherein the clip comprises a recess configured to catch liquid from the bottle.
